(19) United States
(12) Patent Application Publication
(10) Pub. No.: US 2024/0256882 A1
(43) Pub. Date: Aug. 1, 2024

(54) REINFORCEMENT LEARNING BY DIRECTLY LEARNING AN ADVANTAGE FUNCTION

(71) Applicant: DeepMind Technologies Limited, London (GB)

(72) Inventors: Yunhao Tang, London (GB); Remi Munos, London (GB); Mark Daniel Rowland, London (GB); Michal Valko, Paris (FR)

(21) Appl. No.: 18/424,520

(22) Filed: Jan. 26, 2024

Related U.S. Application Data
(60) Provisional application No. 63/481,782, filed on Jan. 26, 2023.

(51) Int. Cl. G06N 3/092

(52) U.S. Cl. CPC G06N 3/092

(57) ABSTRACT

A system and method, implemented by one or more computers, of controlling an agent to take actions in an environment to perform a task is provided. The method comprises maintaining a value function neural network an advantage function neural network that is an estimate of a state-action advantage function representing a relative advantage of performing one possible action relative to the other possible actions. The method further comprises using the advantage function neural network to control the agent to take actions in the environment to perform the task. The method also comprises training the value function neural network and the advantage function neural network in a way that takes into account a behavior policy defined by a distribution of actions taken by the agent in training data.

### CROSS-REFERENCE TO RELATED APPLICATION

This application claims priority under 35 U.S.C. 119 to Provisional Application No. 63/481,782, filed Jan. 26, 2023, which is incorporated by reference.

### BACKGROUND

This specification relates to reinforcement learning.

In a reinforcement learning system an agent interacts with an environment by performing actions that are selected by the reinforcement learning system in response to receiving observations that characterize the current state of the environment. As used herein reinforcement learning includes online reinforcement learning, and also offline reinforcement learning based on previously collected data, e.g. imitation learning.

Some reinforcement learning systems select the action to be performed by the agent in response to receiving a given observation in accordance with an output of a neural network. Neural networks are machine learning models that employ one or more layers of nonlinear units to predict an output for a received input. Some neural networks are deep neural networks that include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification generally describes a reinforcement learning system that controls an agent interacting with an environment.

A Q-value for an action is an estimate of a return rₜ that will result from the agent performing an action a in response to a current observation x, characterizing a current state of the environment, and thereafter selecting future actions performed by the agent in accordance with a current action selection policy for the agent. A return refers to a cumulative measure of rewards received by the system as the agent interacts with the environment over multiple time steps, e.g. a time-discounted sum of rewards. Q-values can be used in reinforcement learning to evaluate an action selection policy or directly to control actions performed by the agent.

A Q-value function can be decomposed into a state-dependent value function V(x) and a residual state-action dependent advantage function A(x,a). This specification describes techniques that can be used to learn an advantage function (and a value function) directly i.e. without needing to learn a Q-function explicitly, and some additional, conceptually related techniques.

In one aspect there is described a method performed by one or more computers, and a corresponding system. The method can be used for controlling an agent to take actions in an environment to perform a task.

The method can comprise maintaining a value function neural network configured to process an observation at a time step (in accordance with value function neural network parameters) to generate an estimate of a value function representing the value of the state of the environment at the time step. The method can further comprise maintaining an advantage function neural network configured to process an observation at a time step (in accordance with advantage function neural network parameters) to generate, for one or more of a plurality of possible actions, an advantage value. For example the advantage function neural network can process the observation to generate an advantage value for each possible action; or the advantage function neural network can process the observation and a possible action (i.e. data characterizing the action) to generate an advantage value for the possible action.

The advantage value can be an estimate of a state-action advantage function representing a relative advantage of performing one of the possible actions in the state of the environment at the time step relative to the other possible actions.

The method can further involve using the advantage function neural network, directly or indirectly, to control the agent to take actions in the environment to perform the task.

In some implementations using the advantage function neural network to control the agent to take actions in the environment to perform the task comprises obtaining an observation characterizing the state of the environment at a time step, processing the observation using the value function neural network to determine a value of the state of the environment at the time step, and processing the observation using the state-action advantage function neural network to determine, for one or more of a plurality of possible actions at the time step, an advantage value of the possible action. The plurality of possible actions need not be all the possible actions.

Optionally one or more Q-values for each of the one or more possible actions at the time step may be determined, in particular by summing the value at the time step and an advantage for each of the one or more possible actions derived from the respective advantage value for the possible action. The one or more advantage values, or the one or more Q-values, can be used to select an action to be taken by the agent. In response to the selected action the system receives a reward.

The reward is generally a scalar numerical value, which may be positive, negative, or zero and can characterize progress of the agent towards completing the task.

As one example, the advantage values, or the Q-values, can themselves be used to select an action to be taken by the agent at the time step. Then an advantage value, or Q-value, may be determined for each of the possible actions. The system can select the action to be performed by the agent based on the advantage values or Q values using any of a variety of techniques, e.g., selecting the action with the highest advantage value or Q value or by mapping the advantage values or Q values to probabilities and sampling an action in accordance with the probabilities. The system can select the action in accordance with an exploration policy e.g. an ϵ-greedy exploration policy (that selects the action with the highest value with probability 1-ϵ, randomly selecting the action from the possible actions with probability ϵ).

As another example, the advantage values, or the Q-values, can be used indirectly to select an action to be taken by the agent at the time step. Then the advantage values, or Q-values, may be used to evaluate an action selection policy controlling actions taken by the agent, e.g. to select an action selection policy for use from multiple possible action selection policies, or to improve the action selection policy, e.g. by training the action selection policy using the advantage values, or the Q-values.

In implementations, the method obtains training data comprising, for each of a plurality of time steps, a tuple defining: an observation characterizing a state of an environment at a time step, an action taken by an agent at the time step, a reward received in response to the action, and a subsequent observation characterizing the state of the environment at a subsequent time step. The tuples, which may be termed experience tuples, characterize the behavior of the agent.

The agent may be the same agent or a different agent to that which is controlled to perform the task. The environment may be the same environment or a different (but in general similar) environment to that in which the agent is controlled to perform the task.

For example, in some implementations, the method may be used for offline learning of the value and advantage functions solely from the training data without further interaction of the agent to be controlled with the environment. The training data may then comprise demonstration data e.g. from a human or other agent. Also or instead, the training data may comprise data obtained from past experience of the controlled agent acting in the environment to perform the task, e.g. from a replay buffer of previously stored tuples representing the experience of the controlled agent. That is, in some implementations the method may be used for online (but off-policy) learning.

In some of the “VA-learning” techniques described herein the method can then involve, for each of a plurality of the tuples, training the value function neural network using the observation in the tuple and a value target, and training the advantage function neural network using the observation and action in the tuple and an advantage target. In general the value target is dependent on the reward received in the tuple; e.g. it may be derived from a combination of the reward received and one or more Q-values. The advantage target can comprise a difference between the value target for the tuple and an estimated value of the state of the environment for the observation in the tuple. The estimated value of the state of the environment for the observation in the tuple may be determined from a version of the value function neural network, e.g. from a target value function neural network as described below.

In some other techniques “behavior dueling” described herein the method involves training the value function neural network and the advantage function neural network using the observation and action in the tuple and a behavior dueling target dependent on dependent on a difference between a Q-value derived from the (state) value and advantage value for the observation and action in the tuple and a Q-value target derived from the reward received. The Q-value target may include a term that is a weighted average of Q-values for possible actions at the subsequent state of the environment represented by the subsequent observation. The Q-values may be weighted by a probability of each action according to the current action selection policy (i.e. a policy defined by a Q-value that comprises a sum of the state value and advantage value for the subsequent state).

In VA-learning implementations, one or both of the value target and the advantage target are corrected for a behavior policy of the agent. In “behavior dueling” implementations the Q-value is corrected for a behavior policy of the agent. More specifically the Q-value may be derived from a sum of the (state) value and an advantage derived by subtracting, from the advantage value for the action in the tuple, and a weighted sum of the advantage values for each of the possible actions, wherein the advantage value of each possible action is weighted by a respective probability of the possible action according to the behavior policy.

The behavior policy can be defined by a distribution of actions taken by the agent in the training data for the states of the environment in the training data. Thus the behavior policy of the agent may be defined by the past policy of the agent or, e.g. in offline reinforcement learning, by the behavior policy of the agent used to provide the training data.

In some implementations, the method can maintain a behavior policy neural network configured to process an observation at a time step to generate a behavior policy output representing the probability of an action being selected according to the behavior policy. The method can then involve correcting one or both of the value target and the advantage target based on the behavior policy output.

In general, the value function neural network, the state-action advantage function neural network, and behavior policy neural network can have any appropriate architecture including, e.g. one or more of a feedforward architecture, a recurrent architecture, and an attention-based architecture. In some implementations the value function neural network, the state-action advantage function neural network, and the behavior policy neural network may share parts of their neural network architecture, e.g. to process observations.

The method can update the behavior policy neural network, more particularly parameters of the behavior policy neural network, by training the behavior policy neural network using the actions selected to be taken by the controlled agent i.e. using the actions selected by the above described method as action targets. Thus the behavior policy neural network can learn the behavior policy of the agent. Any appropriate training objective may be used, e.g. a log likelihood objective.

In general training of a neural network as described herein may involve backpropagating gradients of an objective function, e.g. based on the value target, advantage target, or action targets.

In implementations correcting the value target and/or the advantage target based on the behavior policy output can involve using an action defined by the behavior policy output to determine a correction for the value target and/or the advantage target. More particularly correcting the value target based on the behavior policy of the agent can comprise subtracting, from the value target, an estimate of a state-action advantage for an action, determined according to the behavior policy, for the subsequent observation in the tuple. Correcting the advantage target based on the behavior policy of the agent can comprise subtracting, from the advantage target, an estimate of a state-action advantage for an action, determined according to the behavior policy, for the subsequent observation in the tuple. In some implementations, the estimate of the state-action advantage for the action may be determined from a version of the advantage function neural network, e.g. from a target advantage function neural network as described below.

In some implementations, the advantage for a possible action is equal to the advantage value for the possible action. In some implementations, the advantage for a possible action is derived by subtracting, from the advantage value for the possible action (ƒ(x,a)), a weighted sum of the advantage values for each of the possible actions (based on the current observation, e.g. as in the tuple). In implementations, the advantage value of each possible action is weighted by a respective probability of the possible action according to the behavior policy. In implementations, the respective probability of the possible action is determined from the behavior policy output.

In implementations where the value function neural network and the advantage function neural network are trained (jointly) based on the difference between a Q-value and a Q-value target, they may be trained based on a difference between the Q-value target and a sum of the value for the observation in the tuple and the advantage for the observation and action in the tuple, i.e. on a reinforcement learning objective based on this difference.

As previously described, in some implementations obtaining the training data involves maintaining buffer memory storing the tuples, and adding tuples into the buffer memory based on observations of the environment, selected actions, and rewards obtained as the agent is controlled to take actions in the environment to perform the task. When the replay buffer is full the oldest entries may be overwritten, i.e. the replay buffer may track only recent behavior of the agent; or the buffer memory may be sufficiently large that it does not become full.

As previously described, in some implementations the advantage function neural network is configured to process an observation at a time step to generate an estimate of the state-action advantage function for each of the plurality of possible actions. The method may further comprise processing the observation obtained at the time step using the state-action advantage function neural network to determine, for each of the plurality of possible actions at the time step, an advantage value of the possible action, and optionally determining a Q-value for each of the one or more possible actions at the time step. Using the one or more advantage values, or the one or more Q-values, to select an action to be taken by the agent may comprise selecting the action based on the advantage value (or advantage) or Q-value for each of the possible actions.

In some implementations, the advantage function neural network is configured to process an observation and an action at a time step to generate an estimate of the state-action advantage function for the action. The method may further comprise processing observations of the environment using an action selection policy neural network, defining an action selection policy, to generate an action selection output used to select the actions performed by the agent in the environment. Using the one or more advantage values or the one or more Q-values to select an action to be taken by the agent can comprises training the action selection policy neural network (to update parameters of the action selection policy neural network) using either the advantage values (or advantages) or the Q-values.

There are many ways in which Q-values or advantage values can be used to update an action selection policy, e.g. by training the action selection policy neural network. As one example the Q-values or advantage values can be used to evaluate an action selection policy neural network defined by the action selection policy neural network, and thus to improve action selection policy, e.g. in an actor-critic approach. For example in MPO (Maximum a Posteriori Policy Optimization, Abdolmaleki et al., 2018), or variants thereof, Q-values are used to obtain an improved version of the action selection policy in closed (algebraic) form. The action selection policy neural network is then trained using an objective based on the improved version of the action selection policy, e.g. by adjusting the action selection policy towards the improved version of the action selection policy, in particular subject to a trust region (KL) constraint.

The described techniques can be implemented in a distributed system, e.g. one in which there are multiple learner systems each implementing the method, or in which there are multiple actor systems each implementing a respective action selection policy neural network.

In some implementations, the value target comprises a temporal difference value target based on a sum of the reward and a product of a discount factor and one or more Q-values for the subsequent observation, e.g. for a maximum Q-value or an average of Q-values over actions. The advantage target can comprise a temporal difference advantage target based on the temporal difference value target. Such a temporal difference targets may comprise 1-step targets or n-step targets (n>1). For example the system can determine a discounted sum of n rewards over n time steps, and the one or more Q-values for the n+1th step; the correction may also be determined for the n+1th observation.

In some implementations, the method includes maintaining a target value function neural network and a target advantage function neural network that each have the same architecture as the respective value function neural network and advantage function neural network but have parameter values that are constrained to change more slowly than the respective value function neural network and advantage function neural network during training. The temporal difference value target and the temporal difference advantage target are determined using the target value function neural network and the target advantage function neural network respectively.

In implementations, the value of the state of the environment at the time step and the advantage value of the possible action are both determined without maintaining a Q-value neural network that is configured to process an observation to generate a Q-value.

In some cases an observation as described above may be represented by an observation embedding; similarly an action may be represented by an action embedding. An embedding of an entity, e.g., an observation of an environment, can refer to a representation of the entity as an ordered collection of numerical values, e.g., a vector or matrix of numerical values; it can be generated, e.g., as the output of a neural network that processes data characterizing the entity.

There is also described an agent including a system to select actions to be performed by the agent to control the agent to perform a task in an environment. The system comprises an advantage function neural network configured to process an observation at a time step to generate, for one or more of a plurality of possible actions, an advantage value that is an estimate of a state-action advantage function representing a relative advantage of performing one of the possible actions in the state of the environment at the time step relative to the other possible actions. The action selection neural network system can have been trained as described above.

Particular embodiments of the subject matter described in this specification can be implemented so as to realize one or more of the following advantages.

Often determining the relative performance of different actions is what is useful in reinforcement learning, but hitherto it has not been possible to learn an advantage function directly. The described techniques can be used to learn an advantage function and a value function directly i.e. without needing to learn a Q-function explicitly. They also have a principled theoretical underpinning, and are thus trustworthy.

Implementations of the described techniques can also reduce the computational resources needed for reinforcement learning because they can increase the speed at which learning takes place, and can also achieve superior final performance. In particular by separating the learning of the value function and the advantage function the value function is enabled to learn relatively quickly whilst the advantage function can be learned more slowly. Overall this can result in a significant increase in the speed at which both functions are learned compared with techniques that learn the Q-function, and the final performance is also improved.

The method can be implemented as part of a reinforcement learning system, such as the reinforcement learning system 200 described below in connection with FIG. 2. The reinforcement learning system is an example of a system implemented as computer programs on one or more computers in one or more locations in which the systems, components, and techniques described are implemented. The reinforcement learning system selects actions to be performed by an agent interacting with an environment at each of multiple successive time steps. At each time step, the system receives data characterizing the current state of the environment, e.g., an image of the environment, and selects an action to be performed by the agent in response to the received data. Data characterizing a state of the environment is referred herein as an observation.

Once the reinforcement learning system selects an action to be performed by the agent, the reinforcement learning system can cause the agent to perform the selected action. For example, the system can instruct the agent and the agent can perform the selected action. As another example, the system can directly generate control signals for one or more controllable elements of the agent. As yet another example, the system can transmit data specifying the selected action to a control system of the agent, which controls the agent to perform the action. Generally, the agent performing the selected action results in the environment transitioning into a different state.

Whilst in general neural networks are used to estimate the value and advantage functions, other “tabular” implementations may alternatively or additionally derive value and advantage functions explicitly for all state-action combinations.

### BRIEF DESCRIPTION OF THE DRAWINGS

FIG. 1 shows an example system for controlling an agent to take actions in an environment to perform a task.

FIG. 2 shows an example Q-value neural network comprising value and advantage neural networks for obtaining Q-values from an observation.

FIG. 3 shows an example system for training the value and advantage neural networks of FIG. 2.

FIG. 4 is a flow diagram of an example process for controlling an agent to take actions in an environment to perform a task.

FIG. 5 is a flow diagram of an example process for training a neural network for controlling an agent.

FIG. 6 is a graph showing exemplary results comparing conventional Q-learning and dueling Q-learning methods with the VA-learning and Behavior Dueling methods described herein.

Like reference numbers and designations in the various drawings indicate like elements.

### DETAILED DESCRIPTION

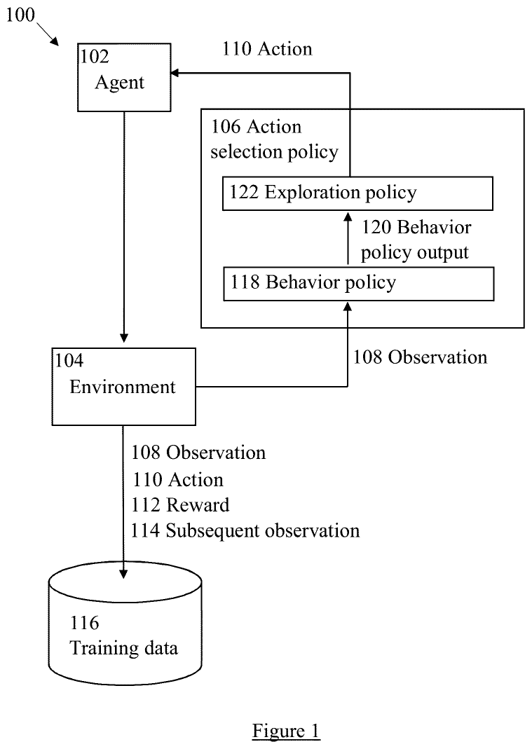

FIG. 1 shows a computer system 100 comprising an agent 102 that interacts with an environment 104 to perform a task. The computer system 100 is an example of a system, implemented as computer programs on one or more computers in one or more locations, in which the systems, components, and techniques described below are implemented.

The agent 102 is controlled by an action selection policy 106 that is configured to receive an observation xₜ 108 characterizing a current state of the environment 104, and to generate, in response to the observation 108, an action a 110 to be performed by the agent 102 performing the task. After the agent 102 performs the action 110, a reward rₜ 112 is generated from the environment 104 in response to the action 210, and a subsequent observation xₜ₊₁ 114 characterizing the state of the environment 104 at a subsequent time step (t+1) is provided to the action selection policy 106 in order to determine a subsequent action to be performed by the agent 102, and so on.

The reward rₜ 114 is a scalar numerical value, which may be positive, negative, or zero and which characterizes progress of the agent 102 towards completing the task. The observation 108 and the subsequent observation 114 are each representations of the environment 104 as a respective ordered collection of numerical values (e.g., a vector or matrix of numerical values) generated, for example, as the output of a neural network that processes data characterizing the environment 104.

The action selection policy 106 comprises a behavior policy μ 118 that is configured to process an observation 108 at a time step to generate a behavior policy output 120 representing the probability μ(a|xₜ) of an action being selected according to the behavior policy 118. The behavior policy u may be implemented as a behavior policy neural network, for example.

The action selection policy 106 further comprises an exploration policy 122 configured to use the behavior policy output 120 to select the action 110 to be performed by the agent 102. In some implementations, the probability of each action being selected is the corresponding probability μ(a|xₜ) determined from the behavior policy. In other implementations, the exploration policy may be (for example) an ϵ-greedy exploration policy that selects the action with the highest probability μ(a|xₜ), determined using the behavior policy 118, with a probability 1-ϵ, and randomly selects the action from the other possible actions with probability ϵ. Thus, at each of a plurality of time steps, the action selection policy 106 samples an action at to perform from the behavior policy μ 118 that depends on an observation xₜ 108 characterizing a current state of the environment, i.e., μ˜μ(·|xₜ).

The computer system 100 also includes a training data store (or buffer) that stores training data 116 that can be used for improving the action selection (or behavior) policy 106, or training a new action selection (or behavior) policy, as described below. The training data store may be a replay buffer of previously stored tuples representing the experience of the controlled agent 102. That is, the training data 116 may comprise, for each of the plurality of time steps, a tuple (xₜ, aₜ, rₜ, xₜ₊₁) defining: the observation xₜ 108 characterizing a state of the environment 104 at the time step t, the action aₜ 110 taken by the agent at the time step, the reward rₜ 112 received in response to the action 110, and the subsequent observation xₜ₊₁ 114 characterizing the state of the environment 104 at a subsequent time step (t+1). In other implementations, where saving of the training data 116 is not required, the training data store may be omitted.

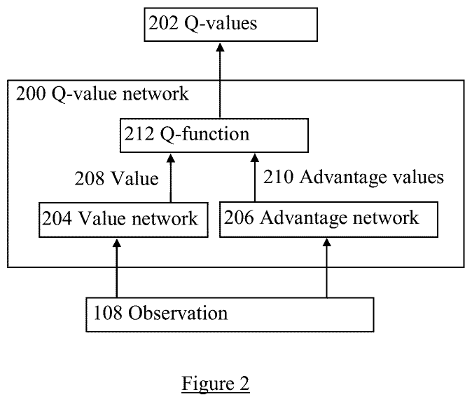

FIG. 2 shows a Q-value neural network 200 that is configured to determine one or more Q-values 202 for each of one or more of a plurality of possible actions that may be performed by the agent 102. The Q-value neural network 200 may be used to determine a behavior policy, such as the behavior policy 118 used to control the agent 102. Each of the Q-values 204 is an estimate of a reward or return that will result from the agent 102 performing the corresponding action 110 in response to the current observation xₜ 108 characterizing the current state of the environment 104. The plurality of possible actions may comprise all of the possible actions that may be performed by the agent 102, or only some of them.

The Q-value neural network 200 comprises a (state) value function neural network V_{θ} 204, parametrized with trainable value function neural network parameters θ, and a (state-action) advantage function neural network A_{φ} 206, parameterized with trainable with advantage function neural network parameters φ. In general, the value function neural network 204, and the state-action advantage function neural network 206 can have any appropriate architecture including, e.g. one or more of a feedforward architecture, a convolutional architecture, a recurrent architecture, an attention-based architecture, and so on.

The value function neural network 204 is configured to process the observation 108 to generate an estimate of a value function representing the value V_{θ}(xₜ) 208 of the state of the environment 104.

The advantage function neural network 206 is configured to process the observation 108 to generate, for one or more of the possible actions, an advantage value A_{φ}(xₜ,a) 210 that is an estimate of a state-action advantage function representing a relative advantage of performing one of the possible actions in the state of the environment 104 relative to the other possible actions.

The Q-value neural network 200 further comprises a Q-function Q_{θ,φ} 212 configured to generate the Q-values Q_{θ,φ}(xₜ,a) 202 for each of the one or more possible actions by summing the value 208 and an advantage (e.g. advantage value 210) for each of the one or more possible actions derived from the respective advantage value 124 for the possible action, i.e.,

$${Q}_{θ , φ} ( {x}_{t} , a ) = {V}_{θ} ( {x}_{t} ) + {A}_{φ} ( {x}_{t} , a ) .$$

The advantage function neural network 206 can be used, directly or indirectly, to control the agent 102 to take actions in the environment 104 to perform the task. For example, the behavior policy 118 may be trained using the Q-values 202 generated by the Q-value neural network 200 to optimize the rewards 112 received in response to the actions 110 performed by the agent 102. As another example, the advantage values 210, or the Q-values 210, can themselves be used to select the action 110 to be taken by the agent 102 at the time step. The system can then select the action 110 to be performed by the agent 102 based on the advantage values 210 or the Q-values 202 using any of a variety of techniques, e.g., selecting the action with the highest advantage value 210 or Q-value 202 or by mapping the advantage values 210 or Q-values 202 to probabilities and sampling an action 110 in accordance with the probabilities.

Compared to other methods in which advantage functions are learnt implicitly via Q-functions, the present methods can learn advantage functions directly. In particular, the VA-learning and behavior dueling methods described herein do not maintain a separate Q-function 212, but rather calculate Q-values 202 from the corresponding state-dependent value 208 and state-action advantages 210. Unlike a Q-function, an advantage function does not obey a recursive equation (like the Bellman equation for Q-functions) and cannot be learned as a standalone object by bootstrapping from itself. Nevertheless, as described below, an advantage function can be learnt by learning a value function at the same time as the advantage function. This approach has been observed to be generally superior to vanilla Q-learning in both tabular and deep RL settings.

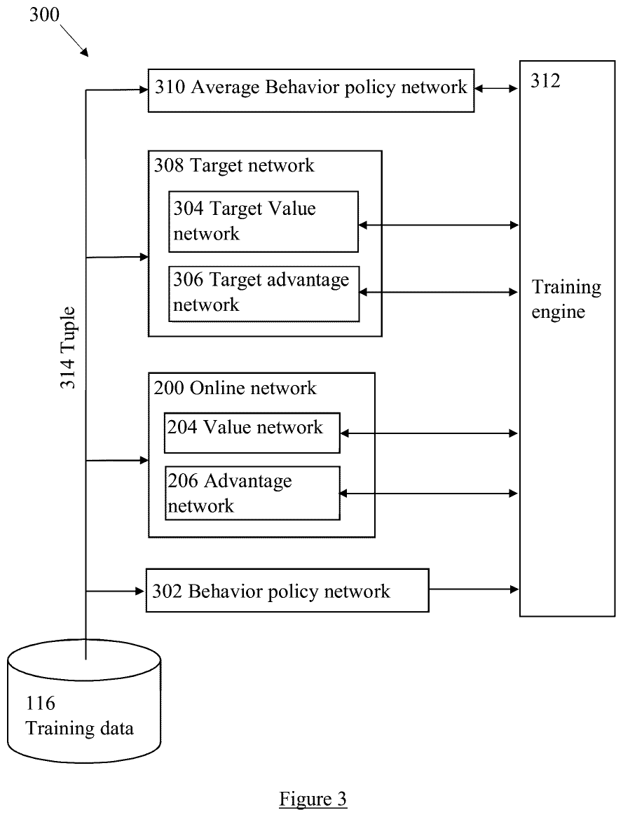

FIG. 3 shows a reinforcement learning system 300 for training the Q-value neural network 200 (which is referred to as an “online” neural network 200 in the context of FIG. 3), according to a behavior policy, which is implemented as a behavior policy neural network π 302. The reinforcement learning system 300 comprises a training data store (or buffer) that stores training data 116 generated by the computer system 100 using the behavior policy μ 118 described above in connection with FIG. 1.

The training system 200 also includes an average behavior policy neural network μ_{ψ} 310, which is used to learn an average behavior of the behavior policy μ 118 that was used by the action selection policy 106 to select the actions taken by the agent 102 in the training data 116. The average behavior policy neural network μ_{ψ} 310 is parameterized with trainable average behavior policy neural network parameters w. Once trained, the average behavior policy neural network μ_{ψ} 310 may, in some cases, be used to control an agent, such as the agent 102 described in connection with FIG. 1, or the average behavior policy neural network μ_{ψ} 310 may be used only for training the value function neural network 204 and the advantage function neural network 206, e.g. it may be discarded after the training process has terminated.

The reinforcement learning system 300 also includes a target neural network 308 that is a version of the Q-value neural network 200 and comprises a target value function neural network V_{θ}_{^{−}}304, parameterized with trainable target value function neural network parameters θ⁻, and a target advantage function neural network A_{φ}_{^{−}} 306, parameterized with trainable target advantage function neural network parameters φ⁻.

The target value function neural network V_{θ}_{^{−}} 304 is configured to process an observation xₜ 108 at a time step (in accordance with the target value function neural network parameters θ⁻) to generate an estimate of a target value function a the target value V_{θ}_{^{−}}(xₜ) of the state of the environment 104 at the time step.

The target advantage function neural network A_{φ}_{^{−}} 206 is configured to process an observation xₜ 108 at a time step (in accordance with the target advantage function neural network parameters φ⁻) to generate, for one or more (e.g. each) of the plurality of possible actions a, a target advantage value A_{φ}_{^{−}}(xₜ,a).

The target network 206 is configured to use the target value neural network V_{θ}_{^{−}} 218 to determine target Q-values Q_{θ}_{^{−}}_{,φ}_{^{−}}(xₜ,a) for each of the possible actions by summing the target value V_{θ}_{^{−}}(xₜ) generated by the target value neural network V_{θ}_{^{−}} 212 and the target advantage values A_{φ}_{^{−}}(xₜ,a) generated by the target advantage neural network 214 for each of the possible actions, i.e.:

$${Q}_{{θ}^{-} , {φ}^{-}} ( {x}_{t} , a ) = {V}_{{θ}^{-}} ( {x}_{t} ) + {A}_{{φ}^{-}} ( {x}_{t} , a ) .$$

The target value function neural network V_{θ}_{^{−}} 304 and the target advantage function neural network A_{φ}_{^{−}} 306 each have the same architecture as the respective value function neural network V_{θ} 204 and advantage function neural network A_{φ} 206, but have parameter values θ⁻,φ⁻ that change more slowly than the parameters of the respective value function neural network 204 and advantage function neural network 206 during training.

The reinforcement learning system 300 also comprises a training engine 312 that is configured to train the value function neural network V_{θ} 204, the advantage function neural network A_{φ} 206 and the average behavior policy neural network μ_{ψ} 310.

To carry out the training, the reinforcement learning system 300 is configured to retrieve, for each of the plurality of time steps, a corresponding tuple (xₜ,aₜ,rₜ,xₜ₊₁) 314 from the training data 116 and to update, based on the tuple 314, the trainable parameters of each of the value function neural network V_{θ} 204, the advantage function neural network A_{φ} 206 and the average behavior policy neural network μ_{ψ} 310.

The reinforcement learning system 300 is configured for offline learning, such that the learning of the value and advantage functions occurs solely from the training data 116 without further interaction of the agent 102 to be controlled with the environment 104. However, in general, the training data 116 need not be obtained using the computer system 100 described above in connection with FIG. 1, but can additionally or alternatively be obtained in any appropriate way, e.g. from demonstration data e.g. from a human or other agent.

In other implementations, the reinforcement learning system 300 may be configured for online learning, such that the learning of the value and advantage functions occurs from training data that is generated by the agent 102 performing actions 110 that have been selected based on the value function neural network 204 and/or the advantage function neural network 206, or based on the target value function neural network 304 and/or the target advantage function neural network 306.

### VA-Learning

In implementations, the training engine 312 is configured to train the value function neural network V_{θ} 204 using the observation xₜ 108 in the tuple 215 and a value target \hat{V}(xₜ) dependent on the reward rₜ 112 received.

The target network 200 uses the target value neural network 304 to determine the value target \hat{V}(xₜ), which comprises a temporal difference target based on a sum of the reward 112 and a product of a discount factor γ and one or more target Q-values 202 for the subsequent observation xₜ₊₁ 114, e.g. for a maximum Q-value 208 or an average of Q-values 202 over actions.

For example, the temporal difference (back-up) target \hat{Q}^{π}(xₜ,aₜ) may be determined by summing the reward rₜ 112 and a product of a discount factor γ∈[0, 1) with one or more target Q-values Q_{θ}_{^{−}}_{,φ}_{^{−}}(xₜ₊₁,π) for the subsequent observation (xₜ₊₁) and the behavior policy π 302, i.e., from:

$${\hat{Q}}^{π} ( {x}_{t} , {a}_{t} ) = {r}_{t} + {γQ}_{{θ}^{-} {φ}^{-}} ( {x}_{t + 1} , π ) ,$$

where Q_{θ}_{^{−}}_{,φ}_{^{−}}(xₜ₊₁,π)=V_{θ}_{^{−}}(xₜ₊₁)+A_{φ}_{^{−}}(xₜ₊₁,π), is an estimate of the return that will result from the agent 102 following the behavior policy π 302 after the subsequent observation xₜ+1 of the environment 104.

The Q-value target Q™ (xₜ,aₜ) includes a term that is a weighted average of Q-values for possible actions at the subsequent state of the environment represented by the subsequent observation. In particular, the Q-values are weighted by a probability of each action according to the current behavior selection policy 302 (i.e. a policy defined by a Q-value 202 that comprises a sum of the state value and advantage value for the subsequent state). The target Q-value is an estimate of the return that will result from the agent 102 following the behavior policy Tt 302 after the subsequent observation xₜ₊₁ of the environment 104.

The temporal difference target may comprise a 1-step target, as in the present implementation, or n-step targets (n>1). For example the target network 308 can determine a discounted sum of n rewards over n time steps, and the one or more target Q-values for the n+1th step.

The advantage value A_{φ}_{^{−}}(xₜ,π) for the behavior policy π 302 is defined as a sum over target advantage values generated by the target advantage function neural network 306 for each available action weighted by the probability of that action according to the behavior policy π 302, i.e. A_{φ}_{^{−}}(xₜ,π)=Σₐπ(a|xₜ)A_{φ}_{^{−}}(xₜ,a).

The training engine 312 is configured to correct the value target \hat{V}(xₜ) for the behavior policy μ 118 used by the agent 102 in the training data 116 by subtracting the discounted advantage value γA_{φ}_{^{−}}(x+1,μ), determined for the behavior policy μ 118, from the temporal difference target \hat{Q}^{π}(xₜ,aₜ), determined for the behavior policy π 302, i.e.,

$$\hat{V} ( {x}_{t} ) = {\hat{Q}}^{π} ( {x}_{t} , {a}_{t} ) - γ {A}_{{φ}^{-}} ( {x}_{t + 1} , μ ) ,$$

where the advantage value A_{φ}(xₜ,μ) for the behavior policy μ 118 used to generate the training data 116 is defined as a sum over advantage values generated by the advantage function neural network 306 for each available action weighted by the probability of that action according to the behavior policy μ 118, i.e. A_{φ}(xₜ,μ)=Σₐμ(a|xₜ)A_{φ}(xₜ,a).

The training engine 312 is further configured to train the advantage function neural network A_{φ} 306 using the observation xₜ 108 and action aₜ 110 in the tuple 314 and an advantage target Â(xₜ,aₜ), which comprises a difference between the value target \hat{V}(xₜ) for the tuple 314 and the estimated (target) value V_{θ}_{^{−}}(xₜ) of the state of the environment 104 for the observation xₜ 108 in the tuple 314, i.e.,

$$\hat{A} ( {x}_{t} , {a}_{t} ) = \hat{V} ( {x}_{t} ) - {V}_{{θ}^{-}} ( {x}_{t} ) = \hat{Q} ( {x}_{t} , {a}_{t} ) - γ {A}_{φ} - ( {x}_{t + 1} , μ ) - {V}_{{θ}^{-}} ( {x}_{t} ) .$$

The advantage function neural network A_{φ} 206 therefore learns a residual of the value target \hat{V} (xₜ) determined by subtracting the estimated target value V_{θ}_{^{−}}(xₜ).

Alternatively, the value V_{θ}(xₜ) 208 determined by the value function neural network 204 may be subtracted from the value target \hat{V}(x+) instead of the estimated target value V_{θ}_{^{−}}(xₜ) determined by the target value function neural network 306, i.e.

$$\hat{A} ( {x}_{t} , {a}_{t} ) = \hat{V} ( {x}_{t} ) - {V}_{θ} ( {x}_{t} ) .$$

This modification has been found to give improvements in deep reinforcement learning applications.

The training engine 312 is also configured to update the parameters w of the average behavior policy neural network μ_{ψ} 310 by training the average behavior policy neural network 310 using the actions 110 selected to be taken by the agent 102, e.g., the action at of the tuple 314. For example, the parameters γ of the average behavior policy neural network μ_{ψ} 310 may be trained using gradient-based optimization, e.g. by maximizing a likelihood log μ_{ψ} (a|x) on observed transitions (xₜ,aₜ), such that the parameters ψ of the average behavior policy neural network μ_{ψ} 310 are updated according to:

$$ψ ← ψ + η {∇}_{ψ} log {μ}_{ψ} ( {a}_{t} \vert {x}_{t} ) ,$$

in which η is a learning rate and ∇_{ψ} denotes a gradient with respect to the average behavior policy neural network parameters ψ.

The training engine 312 is further configured to train the value function neural network V_{θ} 204 and the advantage function neural network A_{φ} 306 by optimizing a suitable training objective, e.g. by minimizing a loss function that depends on: (i) a difference between the value V_{θ}(xₜ) 208 generated by the value function neural network V_{θ}204 for the observation xₜ 108 in the tuple 314 and the value target \hat{V}(xₜ); and (ii) a difference between the advantage value A_{φ}(xₜ,aₜ) 210, generated by advantage function neural network A_{φ} 206, and the advantage target Â(xₜ,aₜ), e.g.,

$${L}_{V A} ( θ , ϕ ) = \frac{1}{2} {( {V}_{θ} ( {x}_{t} ) - {\hat{V}}_{θ} ( {x}_{t} ) )}^{2} + \frac{1}{2} {( {A}_{φ} ( {x}_{t} , {a}_{t} ) - {\hat{A}}_{φ} ( {x}_{t} {ma}_{t} ) )}^{2} .$$

Other forms of training objective function can however be used instead of or in addition to this loss function. For example, a Huber loss function may be used instead of the least-squares loss function L_{VA}(θ,φ).

The loss function L_{VA}(θ,φ) can be minimized using gradient-based optimization, e.g., by updating the trainable parameters train of the value function neural network V_{θ} 204 and the advantage function neural network A_{φ} 206 as follows:

$$( θ , φ ) ← ( θ , φ ) - η {∇}_{( θ , φ )} {L}_{V A} ( θ , φ ) ,$$

where η is a learning rate, which may be the same as, or different from, the learning rate used in training the average behavior policy neural network μ_{ψ} 310, and ∇_{(θ,φ)} denotes a gradient with respect to the parameters (θ,φ) of the value function neural network V_{θ} 304 and the advantage function neural network A_{φ} 306. Learning rates smaller than 2.5·10⁻⁴ (e.g. 1.5·10⁻⁵) have been found to give improved performance. The value function neural network V_{θ} 204 and the advantage function neural network A_{φ} 206 may be trained jointly.

Optimization of the training (loss) functions can be carried out using the RMSProp optimizer, although any known gradient descent optimization algorithm may be used; for example, a standard stochastic gradient descent (SGD) algorithm, the “momentum” algorithm (described in Sutskever et al., “On the importance of initialization and momentum in deep learning”, International conference on machine learning, PMLR, pp. 1139-1147, 2013), the “Adam” algorithm (described in Kingma and Ba, “Adam: A method for stochastic optimization”, arXiv: 1412.6980, 2014), or the like.

During training, the training engine 312 may update the target value function neural network parameters θ⁻ and the target advantage function neural network parameters o″ towards the value function neural network parameters θ and the advantage function neural network parameters φ. This updating may be carried out e.g. after a certain number of updates to the value function neural network parameters θ and the advantage function neural network parameters φ have been carried out (e.g. every 10 updates). See, for example, Mnih et al. “Playing Atari with deep reinforcement learning” arXiv: 1312.5602, 2013. The architectures of the value function neural network 204 and the advantage function neural network 206 may, for example, be based on the DQN agent described in Minh et al.

By decomposing the Q-values 202 as the sum of the estimate of the value function provided by the value function neural network 204 and the estimate of the state-action advantage function provided by the advantage function neural network 206, the present VA-learning method may allow the shared part of the Q-function to be learned quickly (via the value function component), and more slowly via the advantage function component. When the value targets and advantage targets are determined using bootstrapping (i.e. using a temporal difference target), this decomposition increases the speed at which the advantage function can be learned.

Once the value function neural network 204 and the advantage function neural network 206 have been trained, the Q-value neural network 200 can be used to find an optimal behavior policy (or action selection policy) for controlling the agent 102, e.g., π*=arg maxₐ Q*(x,a) with Q-function Q*:=max,Q^{π}(x,a). There are of course many ways in which Q-values or advantage values can be used to update a behavior or action selection policy, e.g. by training the action selection policy neural network, such as an actor-critic approach, MPO, etc.

### Behavior Dueling

In another implementation, the Q-value Q_{θ,φ}(xₜ,aₜ) 202 is instead corrected for the behavior policy μ 118 of the agent 102 used to provide the training data 116. As described below, the Q-value 202 is derived from a sum of the (state) value 208 and an advantage derived by subtracting, from the advantage value 210 for the action in the tuple, and a weighted sum of the advantage values 212 for each of the possible actions, wherein the advantage value 212 of each possible action is weighted by a respective probability of the possible action according to the behavior policy 118.

The training engine 312 is configured to train the value function neural network V_{θ} 204 and the advantage function neural network A_{φ} 206 using the observation xₜ 108 and action at 110 in the tuple 314 and a behavior dueling target dependent on a difference between the Q-value Q_{θ,φ}(xₜ,aₜ) 202, derived from the (state) value V_{θ}(xₜ) 208 and the advantage value A_{φ}(xₜ,aₜ) 210 for the observation xₜ 108 and action aₜ 110 in the tuple 314, and a Q-value target \hat{Q}^{π}(xₜ,aₜ) derived from the reward (rₜ) 112 received, e.g., the behavior dueling target may be:

$${Q}_{θ , φ} ( {x}_{t} , {a}_{t} ) - {\hat{Q}}^{π} ( {x}_{t} , {a}_{t} ) .$$

In this implementation, the advantage function neural network A_{φ} 206 is parameterized to have zero-mean under the behavior policy μ 118 using an unconstrained function ƒ_{φ}(x, a) and a corresponding weighted average (mean) of the function over the behavior policy μ 118, i.e. ƒ_{φ}(x,μ)=Σₐμ(a|x)ƒ_{φ}(x,a). That is, the advantage function neural network A_{φ} 206 is configured to determine a difference between the function and the average of the function over the behavior policy 118,

$${A}_{φ} ( x , a ) = {f}_{φ} ( x , a ) - {f}_{φ} ( x , μ ) .$$

The training engine 314 is configured to train the value function neural network V_{θ} 204 and the advantage function neural network A_{φ} 206 by minimizing a loss function that depends on the behavior dueling target, e.g.,

$${L}_{Q L} ( θ , φ ) = \frac{1}{2} {( {Q}_{θ , ϕ} ( {x}_{t} , {a}_{t} ) - {\hat{Q}}^{π} ( {x}_{t} , {a}_{t} ) )}^{2}$$

The loss function L_{VA}(θ,φ) can be minimized using gradient-based optimization, e.g., by updating the trainable parameters as follows:

$$( θ , φ ) ← ( θ , φ ) - η {∇}_{( θ , φ )} {L}_{V A} ( θ , φ ) ,$$

where η is a learning rate, which may be the same as, or different from, the learning rate used in training the behavior policy neural network μ_{ψ} 310.

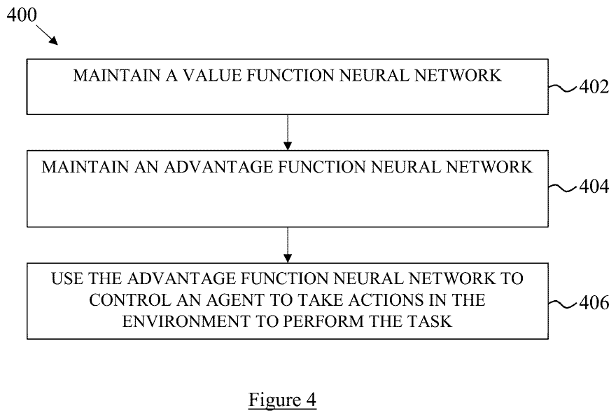

FIG. 4 is a flow diagram of an example process 400 for controlling an agent to take actions in an environment to perform a task. The process may be carried out using one or more computers in one or more locations, e.g. using the system 100 described above with reference to FIG. 1. The process 400 comprises: (step 402) maintaining a (trained) value function neural network, such as the value function neural network 204 described above with reference to FIGS. 2 and 3; and (step 404) maintaining an advantage function neural network, such as the advantage function neural network 206 described above with reference to FIGS. 2 and 3.

The process 400 further comprises (step 406) using the advantage function neural network to control an agent to take actions in the environment to perform the task. As described above, the advantage function neural network may be used directly or indirectly to control the agent to take actions in the environment to perform the task, e.g. by selecting the action having the highest relative advantage in the state of the environment at the time step relative to the other possible actions.

The agent controlled by the process 400 may be the same as or different from the agent used to obtain training data for training the value function neural network and the advantage function neural network. The environment can be the same environment used to obtain the training data, or it can be a different (but in general similar) environment. For example, the agent controlled by the process 400 may be a mechanical agent (e.g. a robot or a vehicle) interacting with a real-world environment, whilst the training data may be generated using an agent implemented as one or more computers interacting with an environment that is a simulation of the real-world environment.

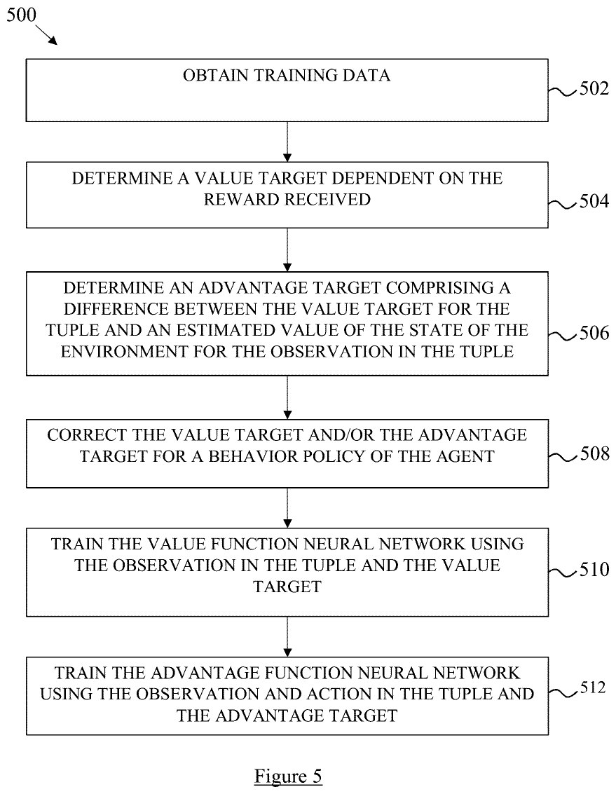

FIG. 5 is a flow diagram of an example process 500 for training a neural network for controlling an agent to take actions in an environment to perform a task. The agent and the environment may be the agent 102 and the environment 104 described above in connection with FIG. 1.

The process 500 comprises obtaining (step 502) training data comprising, for each of a plurality of time steps, a tuple defining: an observation characterizing a state of an environment at a time step, an action taken by an agent at the time step, a reward received in response to the action, and a subsequent observation characterizing the state of the environment at a subsequent time step.

The process 500 further comprises, for each of a plurality of the tuples: determining (step 504) a value target dependent on the reward received; determining (step 506) an advantage target comprising a difference between the value target for the tuple and an estimated value of the state of the environment for the observation in the tuple; and correcting (step 508) the value target and/or the advantage target for a behavior policy of the agent (the behavior policy is defined by a distribution of actions taken by the agent in the training data).

The process 500 further comprises, for each of a plurality of the tuples: training (step 510) the value function neural network using the observation in the tuple and the value target; and training (step 512) training the advantage function neural network using the observation and action in the tuple and the advantage target.

In another implementation, the process 500 can comprise, instead of steps 510 and 512, training the value function neural network and the advantage function neural network using the observation and action in the tuple and a behavior dueling target dependent on a difference between a Q-value derived from the value and advantage value for the observation and action in the tuple and a Q-value target derived from the reward received.

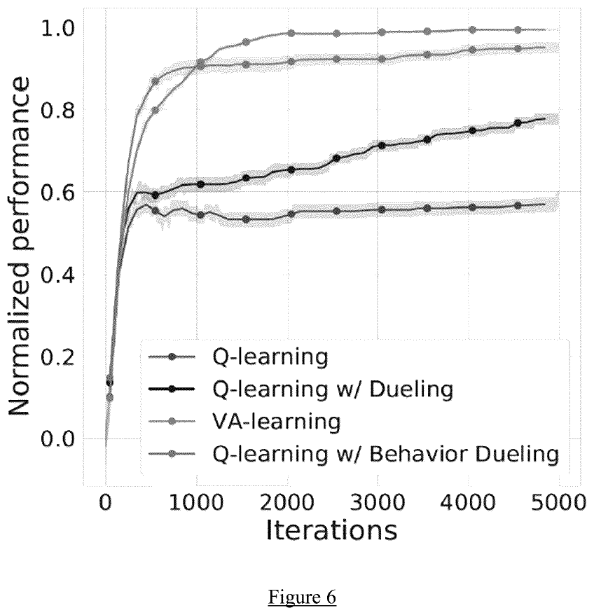

FIG. 6 is a graph showing exemplary results comparing conventional Q-learning and dueling Q-learning with the VA-learning and Behavior Dueling for a tabular Markov Decision Process (MDP) with a fixed behavior policy. The horizontal (X) axis shows the number of iterations (training steps) and the vertical (Y) axis shows a normalized performance obtained by evaluating a greedy policy with the learned Q-function for each of the methods considered. The VA-learning and Behavior Dueling methods are observed to significantly outperform the conventional Q-learning and dueling Q-learning methods, providing improvements in convergence speed and asymptotic accuracy.

### Agent Control

The techniques described herein are widely applicable and are not limited to one specific implementation. However, for illustrative purposes, a small number of example implementations are described below.

In some implementations, the environment is a real-world environment, the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate or manipulate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements e.g. steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation e.g. steering, and movement e.g., braking and/or acceleration of the vehicle.

In some implementations the environment is a simulation of the above-described real-world environment, and the agent is implemented as one or more computers interacting with the simulated environment. For example the simulated environment may be a simulation of a robot or vehicle and the reinforcement learning system may be trained on the simulation and then, once trained, used in the real-world.

In some implementations the environment is a real-world manufacturing environment for manufacturing a product, such as a chemical, biological, or mechanical product, or a food product. As used herein a “manufacturing” a product also includes refining a starting material to create a product, or treating a starting material e.g. to remove pollutants, to generate a cleaned or recycled product. The manufacturing plant may comprise a plurality of manufacturing units such as vessels for chemical or biological substances, or machines, e.g. robots, for processing solid or other materials. The manufacturing units are configured such that an intermediate version or component of the product is moveable between the manufacturing units during manufacture of the product, e.g. via pipes or mechanical conveyance. As used herein manufacture of a product also includes manufacture of a food product by a kitchen robot.

The agent may comprise an electronic agent configured to control a manufacturing unit, or a machine such as a robot, that operates to manufacture the product. That is, the agent may comprise a control system configured to control the manufacture of the chemical, biological, or mechanical product. For example the control system may be configured to control one or more of the manufacturing units or machines or to control movement of an intermediate version or component of the product between the manufacturing units or machines.

As one example, a task performed by the agent may comprise a task to manufacture the product or an intermediate version or component thereof. As another example, a task performed by the agent may comprise a task to control, e.g. minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment e.g. between the manufacturing units or machines. In general the actions may be any actions that have an effect on the observed state of the environment, e.g. actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

The rewards or return may relate to a metric of performance of the task. For example in the case of a task that is to manufacture a product the metric may comprise a metric of a quantity of the product that is manufactured, a quality of the product, a speed of production of the product, or to a physical cost of performing the manufacturing task, e.g. a metric of a quantity of energy, materials, or other resources, used to perform the task. In the case of a task that is to control use a resource the matric may comprise any metric of usage of the resource.

In general observations of a state of the environment may comprise any electronic signals representing the functioning of electronic and/or mechanical items of equipment. For example a representation of the state of the environment may be derived from observations made by sensors sensing a state of the manufacturing environment, e.g. sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions e.g. a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g. data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent in the environment.

In some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control e.g. cooling equipment, or air flow control or air conditioning equipment such as a heater, a cooler, a humidifier, or other hardware that modifies a property of air in the real-world environment. The task may comprise a task to control, e.g. minimize, use of a resource, such as a task to control electrical power consumption, or water consumption. The agent may comprise an electronic agent configured to control operation of the items of equipment, or to control operation of the ancillary, e.g. environmental, control equipment.

In general the actions may be any actions that have an effect on the observed state of the environment, e.g. actions configured to adjust any of the sensed parameters described below. These may include actions to control, or to impose operating conditions on, the items of equipment or the ancillary control equipment, e.g. actions that result in changes to settings to adjust, control, or switch on or off the operation of an item of equipment or an item of ancillary control equipment.

In general observations of a state of the environment may comprise any electronic signals representing the functioning of the facility or of equipment in the facility. For example a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The rewards or return may relate to a metric of performance of the task. For example in the case of a task to control, e.g. minimize, use of a resource, such as a task to control use of electrical power or water, the metric may comprise any metric of use of the resource.

In some implementations the environment is the real-world environment of a power generation facility e.g. a renewable power generation facility such as a solar farm or wind farm. The task may comprise a control task to control power generated by the facility, e.g. to control the delivery of electrical power to a power distribution grid, e.g. to meet demand or to reduce the risk of a mismatch between elements of the grid, or to maximize power generated by the facility. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements e.g. to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g. an efficiency of the conversion or a degree of coupling of the energy input to the electrical energy output. Electrical control actions may, for example, comprise actions that control one or more of a voltage, current, frequency or phase of electrical power generated.

The rewards or return may relate to a metric of performance of the task. For example in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In general observations of a state of the environment may comprise any electronic signals representing the electrical or mechanical functioning of power generation equipment in the power generation facility. For example a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such observations may thus include observations of wind levels or solar irradiance, or of local time, date, or season. Such sensors may include sensors configured to sense electrical conditions of the equipment such as current, voltage, power or energy; temperature or cooling of the physical environment; fluid flow; or a physical configuration of the equipment; and observations of an electrical condition of the grid e.g. from local or remote sensors. Observations of a state of the environment may also comprise one or more predictions regarding future conditions of operation of the power generation equipment such as predictions of future wind levels or solar irradiance or predictions of a future electrical condition of the grid.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that performs or controls the protein folding actions or chemical synthesis steps selected by the system automatically without human interaction. The observations may comprise direct or indirect observations of a state of the protein or chemical/intermediates/precursors and/or may be derived from simulation.

In a similar way the environment may be a drug design environment such that each state is a respective state of a potential pharmaceutically active compound pharmaceutically active compound and the agent is a computer system for determining elements of the pharmaceutically active compound and/or a synthetic pathway for the pharmaceutically active compound. The drug/synthesis may be designed based on a reward derived from a target for the pharmaceutically active compound, for example in simulation. As another example, the agent may be a mechanical agent that performs or controls synthesis of the pharmaceutically active compound.

In some applications the agent may be a software agent i.e. a computer program, configured to perform a task. For example the environment may be a circuit or an integrated circuit design or routing environment and the agent may be configured to perform a design or routing task for routing interconnection lines of a circuit or of an integrated circuit e.g. an ASIC. The reward(s) may then be dependent on one or more routing metrics such as interconnect length, resistance, capacitance, impedance, loss, speed or propagation delay; and/or physical line parameters such as width, thickness or geometry, and design rules. The reward(s) may also or instead include one or more reward(s) relating to a global property of the routed circuitry e.g. component density, operating speed, power consumption, material usage, a cooling requirement, level of electromagnetic emissions, and so forth. The observations may be e.g. observations of component positions and interconnections; the actions may comprise component placing actions e.g. to define a component position or orientation and/or interconnect routing actions e.g. interconnect selection and/or placement actions. The task may be, e.g., to optimize circuit operation to reduce electrical losses, local or external interference, or heat generation, or to increase operating speed, or to minimize or optimize usage of available circuit area. The method may include making the circuit or integrated circuit to the design, or with interconnection lines routed as determined by the method.

In some applications the agent is a software agent and the environment is a real-world computing environment. In one example the agent manages distribution of tasks across computing resources e.g. on a mobile device and/or in a data center. In these applications, the observations may include observations of computing resources such as compute and/or memory capacity, or Internet-accessible resources; and the actions may include assigning tasks to particular computing resources. The reward(s) may be configured to maximize or minimize one or more of: utilization of computing resources, electrical power, bandwidth, and computation speed.

In another example the software agent manages the processing, e.g. by one or more real-world servers, of a queue of continuously arriving jobs. The observations may comprise observations of the times of departures of successive jobs, or the time intervals between the departures of successive jobs, or the time a server takes to process each job, e.g. the start and end of a range of times, or the arrival times, or time intervals between the arrivals, of successive jobs, or data characterizing the type of job(s). The actions may comprise actions that allocate particular jobs to particular computing resources; the reward(s) may be configured to minimize an overall queueing or processing time or the queueing or processing time for one or more individual jobs, or in general to optimize any metric based on the observations.

As another example the environment may comprise a real-world computer system or network, the observations may comprise any observations characterizing operation of the computer system or network, the actions performed by the software agent may comprise actions to control the operation e.g. to limit or correct abnormal or undesired operation e.g. because of the presence of a virus or other security breach, and the reward(s) may comprise any metric(s) that characterizing desired operation of the computer system or network.

In some applications, the environment is a real-world computing environment and the software agent manages distribution of tasks/jobs across computing resources e.g. on a mobile device and/or in a data center. In these implementations, the observations may comprise observations that relate to the operation of the computing resources in processing the tasks/jobs, the actions may include assigning tasks/jobs to particular computing resources, and the reward(s) may relate to one or more metrics of processing the tasks/jobs using the computing resources, e.g. metrics of usage of computational resources, bandwidth, or electrical power, or metrics of processing time, or numerical accuracy, or one or more metrics that relate to a desired load balancing between the computing resources.

In some applications the environment is a data packet communications network environment, and the agent is part of a router to route packets of data over the communications network. The actions may comprise data packet routing actions and the observations may comprise e.g. observations of a routing table which includes routing metrics such as a metric of routing path length, bandwidth, load, hop count, path cost, delay, maximum transmission unit (MTU), and reliability. The reward(s) may be defined in relation to one or more of the routing metrics i.e. configured to maximize one or more of the routing metrics.

In some other applications the environment is an Internet or mobile communications environment and the agent is a software agent which manages a personalized recommendation for a user. The observations may comprise previous actions taken by the user, e.g. features characterizing these; the actions may include actions recommending items such as content items to a user. The reward(s) may be configured to maximize one or more of: an estimated likelihood that the user will respond favorably to being recommended the (content) item, a suitability unsuitability of one or more recommended items, a cost of the recommended item(s), and a number of recommendations received by the user, optionally within a time span.

As a further example, the actions may include presenting advertisements, the observations may include advertisement impressions or a click-through count or rate, and the reward may characterize previous selections of items or content taken by one or more users.

In some cases, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

As another example the environment may be an electrical, mechanical or electro-mechanical design environment, e.g. an environment in which the design of an electrical, mechanical or electro-mechanical entity is simulated. The simulated environment may be a simulation of a real-world environment in which the entity is intended to work. The task may be to design the entity. The observations may comprise observations that characterize the entity, i.e. observations of a mechanical shape or of an electrical, mechanical, or electro-mechanical configuration of the entity, or observations of parameters or properties of the entity. The actions may comprise actions that modify the entity e.g. that modify one or more of the observations. The rewards or return may comprise one or more metric of performance of the design of the entity. For example rewards or return may relate to one or more physical characteristics of the entity such as weight or strength or to one or more electrical characteristics of the entity such as a measure of efficiency at performing a particular function for which the entity is designed. The design process may include outputting the design for manufacture, e.g. in the form of computer executable instructions for manufacturing the entity. The process may include making the entity according to the design. Thus the design of an entity may be optimized, e.g. by reinforcement learning, and then the optimized design output for manufacturing the entity, e.g. as computer executable instructions; an entity with the optimized design may then be manufactured.

As previously described the environment may be a simulated environment. Generally in the case of a simulated environment the observations may include simulated versions of one or more of the previously described observations or types of observations and the actions may include simulated versions of one or more of the previously described actions or types of actions. For example the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. Generally the agent may be implemented as one or more computers interacting with the simulated environment.

The simulated environment may be a simulation of a particular real-world environment and agent. For example, the system may be used to select actions in the simulated environment during training or evaluation of the system and, after training, or evaluation, or both, are complete, may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

In some implementations the agent may not include a human being (e.g. it is a robot). Conversely, in some implementations the agent comprises a human user of a digital assistant such as a smart speaker, smart display, or other device. Then the information defining the task can be obtained from the digital assistant, and the digital assistant can be used to instruct the user based on the task.

For example, the reinforcement learning system may output to the human user, via the digital assistant, instructions for actions for the user to perform at each of a plurality of time steps. The instructions may for example be generated in the form of natural language (transmitted as sound and/or text on a screen) based on actions chosen by the reinforcement learning system. The reinforcement learning system chooses the actions such that they contribute to performing a task. A monitoring system (e.g. a video camera system) may be provided for monitoring the action (if any) which the user actually performs at each time step, in case (e.g. due to human error) it is different from the action which the reinforcement learning system instructed the user to perform. Using the monitoring system the reinforcement learning system can determine whether the task has been completed. During an on-policy training phase and/or another phase in which the history database is being generated, the experience tuples may record the action which the user actually performed based on the instruction, rather than the one which the reinforcement learning system instructed the user to perform. The reward value of each experience tuple may be generated, for example, by comparing the action the user took with a corpus of data showing a human expert performing the task, e.g. using techniques known from imitation learning. Note that if the user performs actions incorrectly (i.e. performs a different action from the one the reinforcement learning system instructs the user to perform) this adds one more source of noise to sources of noise which may already exist in the environment. During the training process the reinforcement learning system may identify actions which the user performs incorrectly with more than a certain probability. If so, when the reinforcement learning system instructs the user to perform such an identified action, the reinforcement learning system may warn the user to be careful. Alternatively or additionally, the reinforcement learning system may learn not to instruct the user to perform the identified actions, i.e. ones which the user is likely to perform incorrectly.

More generally, the digital assistant instructing the user may comprise receiving, at the digital assistant, a request from the user for assistance and determining, in response to the request, a series of tasks for the user to perform, e.g. steps or sub-tasks of an overall task. Then for one or more tasks of the series of tasks, e.g. for each task, e.g. until a final task of the series the digital assistant can be used to output to the user an indication of the task, e.g. step or sub-task, to be performed. This may be done using natural language, e.g. on a display and/or using a speech synthesis subsystem of the digital assistant. Visual, e.g. video, and/or audio observations of the user performing the task may be captured, e.g. using the digital assistant. A system as described above may then be used to determine whether the user has successfully achieved the task e.g. step or sub-task, i.e. from the answer as previously described. If there are further tasks to be completed the digital assistant may then, in response, progress to the next task (if any) of the series of tasks, e.g. by outputting an indication of the next task to be performed. In this way the user may be led step-by-step through a series of tasks to perform an overall task. During the training of the neural network, training rewards may be generated e.g. from video data representing examples of the overall task (if corpuses of such data are available) or from a simulation of the overall task.

As an illustrative example a user may be interacting with a digital assistant and ask for help performing an overall task consisting of multiple steps, e.g. cooking a pasta dish. While the user performs the task, the digital assistant receives audio and/or video inputs representative of the user's progress on the task, e.g. images or video or sound clips of the user cooking. The digital assistant uses a system as described above, in particular by providing it with the captured audio and/or video and a question that asks whether the user has completed a particular step, e.g. ‘Has the user finished chopping the peppers?’, to determine whether the user has successfully completed the step. If the answer confirms that the use has successfully completed the step then the digital assistant progresses to telling the user to perform the next step or, if at the end of the task, or if the overall task is a single-step task, then the digital assistant may indicate this to the user. The digital assistant may then stop receiving or processing audio and/or video inputs to ensure privacy and/or reduce power use.

In a further aspect there is provided a digital assistant device including a system as described above. The digital assistant can also include a user interface to enable a user to request assistance and to output information. In implementations this is a natural language user interface and may comprise a keyboard, voice input-output subsystem, and/or a display. The digital assistant can further include an assistance subsystem configured to determine, in response to the request, a series of tasks for the user to perform. In implementations this may comprise a generative (large) language model, in particular for dialog, e.g. a conversation agent such as LaMDA, Sparrow, or Chinchilla. The digital assistant can have an observation capture subsystem to capture visual and/or audio observations of the user performing a task; and an interface for the above-described language model neural network (which may be implemented locally or remotely). The digital assistant can also have an assistance control subsystem configured to assist the user. The assistance control subsystem can be configured to perform the steps described above, for one or more tasks e.g. of a series of tasks, e.g. until a final task of the series. More particularly the assistance control subsystem and output to the user an indication of the task to be performed, capture, using the observation capture subsystem, visual or audio observations of the user performing the task, determine from the above-described answer whether the user has successfully achieved the task. In response the digital assistant can progress to a next task of the series of tasks and/or control the digital assistant, e.g. to stop capturing observations.

In the implementations above, the environment may not include a human being or animal. In other implementations, however, it may comprise a human being or animal. For example, the agent may be an autonomous vehicle in an environment which is a location (e.g. a geographical location) where there are human beings (e.g. pedestrians or drivers/passengers of other vehicles) and/or animals, and the autonomous vehicle itself may optionally contain human beings. The environment may also be at least one room (e.g. in a habitation) containing one or more people. The human being or animal may be an element of the environment which is involved in the task, e.g. modified by the task (indeed, the environment may substantially consist of the human being or animal). For example the environment may be a medical or veterinary environment containing at least one human or animal subject, and the task may relate to performing a medical (e.g. surgical) procedure on the subject. In a further implementation, the environment may comprise a human user who interacts with an agent which is in the form of an item of user equipment, e.g. a digital assistant. The item of user equipment provides a user interface between the user and a computer system (the same computer system(s) which implement the reinforcement learning system, or a different computer system). The user interface may allow the user to enter data into and/or receive data from the computer system, and the agent is controlled by the action selection policy to perform an information transfer task in relation to the user, such as providing information about a topic to the user and/or allowing the user to specify a component of a task which the computer system is to perform. For example, the information transfer task may be to teach the user a skill, such as how to speak a language or how to navigate around a geographical location; or the task may be to allow the user to define a three-dimensional shape to the computer system, e.g. so that the computer system can control an additive manufacturing (3D printing) system to produce an object having the shape. Actions may comprise outputting information to the user (e.g. in a certain format, at a certain rate, etc.) and/or configuring the interface to receive input from the user. For example, an action may comprise setting a problem for a user to perform relating to the skill (e.g. asking the user to choose between multiple options for correct usage of the language, or asking the user to speak a passage of the language out loud), and/or receiving input from the user (e.g. registering selection of one of the options, or using a microphone to record the spoken passage of the language). Rewards may be generated based upon a measure of how well the task is performed. For example, this may be done by measuring how well the user learns the topic, e.g. performs instances of the skill (e.g. as measured by an automatic skill evaluation unit of the computer system). In this way, a personalized teaching system may be provided, tailored to the aptitudes and current knowledge of the user. In another example, when the information transfer task is to specify a component of a task which the computer system is to perform, the action may comprise presenting a (visual, haptic or audio) user interface to the user which permits the user to specify an element of the component of the task, and receiving user input using the user interface. The rewards may be generated based on a measure of how well and/or easily the user can specify the component of the task for the computer system to perform, e.g. how fully or well the three-dimensional object is specified. This may be determined automatically, or a reward may be specified by the user, e.g. a subjective measure of the user experience. In this way, a personalized system may be provided for the user to control the computer system, again tailored to the aptitudes and current knowledge of the user.

Optionally, in any of the above implementations, the observation at any given time step may include data from a previous time step that may be beneficial in characterizing the environment, e.g., the action performed at the previous time step, the reward received at the previous time step, or both.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method, implemented by one or more computers, of controlling an agent to take actions in an environment to perform a task, the method comprising:
maintaining a value function neural network configured to process an observation at a time step to generate an estimate of a value function representing the value of the state of the environment at the time step;
maintaining an advantage function neural network configured to process an observation at a time step to generate, for one or more of a plurality of possible actions, an advantage value that is an estimate of a state-action advantage function representing a relative advantage of performing one of the possible actions in the state of the environment at the time step relative to the other possible actions; and
using the advantage function neural network to control the agent to take actions in the environment to perform the task;
the method further comprising:
obtaining training data comprising, for each of a plurality of time steps, a tuple defining: an observation characterizing a state of an environment at a time step, an action taken by an agent at the time step, a reward received in response to the action, and a subsequent observation characterizing the state of the environment at a subsequent time step; and, for each of a plurality of the tuples, either
i) training the value function neural network using the observation in the tuple and a value target dependent on the reward received; and
training the advantage function neural network using the observation and action in the tuple and an advantage target comprising a difference between the value target for the tuple and an estimated value of the state of the environment for the observation in the tuple; or
ii) training the value function neural network and the advantage function neural network using the observation and action in the tuple and a behavior dueling target dependent on a difference between a Q-value derived from the value and advantage value for the observation and action in the tuple and a Q-value target derived from the reward received; and
wherein either i) one or both of the value target and the advantage target, or ii) the Q-value, are corrected for a behavior policy of the agent, wherein the behavior policy is defined by a distribution of actions taken by the agent in the training data.

2. The method of claim 1 wherein using the advantage function neural network to control the agent to take actions in the environment to perform the task comprises:
obtaining an observation characterizing the state of the environment at a time step;
processing the observation using the value function neural network to determine a value of the state of the environment at the time step;
processing the observation using the state-action advantage function neural network to determine, for one or more of a plurality of possible actions at the time step, an advantage value of the possible action;
optionally determining one or more Q-values for each of the one or more possible actions at the time step by summing the value at the time step and an advantage for each of the one or more possible actions derived from the respective advantage value for the possible action; and
using the one or more advantage values or the one or more Q-values to select an action to be taken by the agent and, in response to the selected action, receiving a reward.

3. The method of claim 1, further comprising:
maintaining a behavior policy neural network configured to process an observation at a time step to generate a behavior policy output representing the probability of an action being selected according to the behavior policy; and
correcting one or both of the value target and the advantage target based on the behavior policy output.

4. The method of claim 3, wherein maintaining the behavior policy neural network includes:
updating the behavior policy neural network by training the behavior policy neural network using the actions selected to be taken by the agent.

5. The method of claim 1, wherein correcting the value target based on the behavior policy of the agent comprises:
subtracting, from the value target, an estimate of a state-action advantage for an action, determined according to the behavior policy, for the subsequent observation in the tuple.

6. The method of claim 1, wherein correcting the advantage target based on the behavior policy of the agent comprises:
subtracting, from the advantage target, an estimate of a state-action advantage for an action, determined according to the behavior policy, for the subsequent observation in the tuple.

7. The method of claim 2, wherein the advantage for a possible action is equal to the advantage value for the possible action.

8. The method of claim 2, wherein deriving the advantage for a possible action comprises:
subtracting, from the advantage value for the possible action, a weighted sum of the advantage values for each of the possible actions, wherein the advantage value of each possible action is weighted by a respective probability of the possible action according to the behavior policy.

9. The method of claim 8, comprising training the value function neural network and the advantage function neural network based on a difference between the Q-value target and a sum of the value for the observation in the tuple and the advantage for the observation and action in the tuple.

10. The method of claim 8, further comprising:
maintaining a behavior policy neural network configured to process an observation at a time step to generate a behavior policy output representing the probability of an action being selected according to the behavior policy; and
correcting one or both of the value target and the advantage target based on the behavior policy output; and
determining the respective probability of the possible action according to the behavior policy from the behavior policy output.

11. The method of claim 1, further comprising correcting both the value target and the advantage target for the behavior policy of the agent.

12. The method of claim 1, wherein obtaining training data comprises:
maintaining buffer memory storing the tuples; and
adding tuples into the buffer memory based on observations of the environment, selected actions, and rewards obtained as the agent is controlled to take actions in the environment to perform the task.

13. The method of claim 2, wherein the advantage function neural network is configured to process an observation at a time step to generate an estimate of the state-action advantage function for each of the plurality of possible actions; the method further comprising:
processing the observation obtained at the time step using the state-action advantage function neural network to determine, for each of the plurality of possible actions at the time step, an advantage value of the possible action; and
optionally determining a Q-value for each of the one or more possible actions at the time step;
wherein using the one or more advantage values or the one or more Q-values to select an action to be taken by the agent comprises selecting the action based on the advantage value or Q-value for each of the possible actions.

14. The method of claim 2, wherein the advantage function neural network is configured to process an observation and an action at a time step to generate an estimate of the state-action advantage function for the action; the method further comprising:
processing observations of the environment using an action selection policy neural network, defining an action selection policy, to generate an action selection output used to select the actions performed by the agent in the environment; and
wherein using the one or more advantage values or the one or more Q-values to select an action to be taken by the agent comprises training the action selection policy neural network using either the advantage values or the Q-values.

15. The method of claim 14, wherein training the action selection policy neural network comprises:
using the Q-values to obtain an improved version of the action selection policy; and
training the action selection policy neural network using an objective based on the improved version of the action selection policy.

16. The method of claim 1, wherein the value target comprises a temporal difference value target based on a sum of the reward and a product of a discount factor and one or more Q-values for the subsequent observation; and wherein the advantage target comprises a temporal difference advantage target based on the temporal difference value target.

17. The method of claim 16, further comprising maintaining a target value function neural network and a target advantage function neural network that each have the same architecture as the respective value function neural network and advantage function neural network but have parameter values that are constrained to change more slowly than the respective value function neural network and advantage function neural network during training; and wherein the value target and the advantage target are determined using the target value function neural network and the target advantage function neural network respectively.

18. The method of claim 1, wherein the value of the state of the environment at the time step and the advantage value of the possible action are both determined without maintaining a Q-value neural network that is configured to process an observation to generate a Q-value.

19. One or more computer-readable storage media storing instructions that when executed by one or more computers cause the one or more computers to perform operations for controlling an agent to take actions in an environment to perform a task, the operations comprising:
maintaining a value function neural network configured to process an observation at a time step to generate an estimate of a value function representing the value of the state of the environment at the time step;
maintaining an advantage function neural network configured to process an observation at a time step to generate, for one or more of a plurality of possible actions, an advantage value that is an estimate of a state-action advantage function representing a relative advantage of performing one of the possible actions in the state of the environment at the time step relative to the other possible actions; and
using the advantage function neural network to control the agent to take actions in the environment to perform the task;
the method further comprising:
obtaining training data comprising, for each of a plurality of time steps, a tuple defining: an observation characterizing a state of an environment at a time step, an action taken by an agent at the time step, a reward received in response to the action, and a subsequent observation characterizing the state of the environment at a subsequent time step; and, for each of a plurality of the tuples, either
i) training the value function neural network using the observation in the tuple and a value target dependent on the reward received; and
training the advantage function neural network using the observation and action in the tuple and an advantage target comprising a difference between the value target for the tuple and an estimated value of the state of the environment for the observation in the tuple; or
ii) training the value function neural network and the advantage function neural network using the observation and action in the tuple and a behavior dueling target dependent on a difference between a Q-value derived from the value and advantage value for the observation and action in the tuple and a Q-value target derived from the reward received; and
wherein either i) one or both of the value target and the advantage target, or ii) the Q-value, are corrected for a behavior policy of the agent, wherein the behavior policy is defined by a distribution of actions taken by the agent in the training data.

20. A system comprising one or more computers and one or more storage devices storing instructions that when executed by one or more computers cause the one or more computers to perform operations for controlling an agent to take actions in an environment to perform a task, the operations comprising:
maintaining a value function neural network configured to process an observation at a time step to generate an estimate of a value function representing the value of the state of the environment at the time step;
maintaining an advantage function neural network configured to process an observation at a time step to generate, for one or more of a plurality of possible actions, an advantage value that is an estimate of a state-action advantage function representing a relative advantage of performing one of the possible actions in the state of the environment at the time step relative to the other possible actions; and
using the advantage function neural network to control the agent to take actions in the environment to perform the task;
the method further comprising:
obtaining training data comprising, for each of a plurality of time steps, a tuple defining: an observation characterizing a state of an environment at a time step, an action taken by an agent at the time step, a reward received in response to the action, and a subsequent observation characterizing the state of the environment at a subsequent time step; and, for each of a plurality of the tuples, either
i) training the value function neural network using the observation in the tuple and a value target dependent on the reward received; and
training the advantage function neural network using the observation and action in the tuple and an advantage target comprising a difference between the value target for the tuple and an estimated value of the state of the environment for the observation in the tuple; or
ii) training the value function neural network and the advantage function neural network using the observation and action in the tuple and a behavior dueling target dependent on a difference between a Q-value derived from the value and advantage value for the observation and action in the tuple and a Q-value target derived from the reward received; and
wherein either i) one or both of the value target and the advantage target, or ii) the Q-value, are corrected for a behavior policy of the agent, wherein the behavior policy is defined by a distribution of actions taken by the agent in the training data.
